(19) United States
(12) Patent Application Publication
(10) Pub. No.: US 2018/0345157 A1
(43) Pub. Date: Dec. 6, 2018

(54) TOY SET

(71) Applicant: The Foreign Candy Company, Inc., Hull, IA (US)

(72) Inventor: Peter W. De Yager, Hull, IA (US)

(21) Appl. No.: 15/607,864

(22) Filed: May 30, 2017

(51) Int. Cl. A63H 3/00; A63F 1/04; A63H 3/52; A23G 3/50

(52) U.S. Cl. CPC A63H 3/003; A63F 1/04; A63H 3/36; A23G 3/50; A63H 3/52

(57) ABSTRACT

Disclosed is a toy set that includes a figurine representing a miniature reproduction of an animal. Also included in the toy set is a collection identifier that identifies the figurine and a redemption card configured for the collection identifier to be affixed thereto. There is a tangible medium having instructions provided thereon, wherein the instructions specify a manner in which the redemption card may be submitted to redeem a prize. The toy set also may include a carrying case comprising a first portion and a second portion structured and arranged for connection to the first portion to define a storage compartment structured and arranged to contain the figurine, the collection identifier, the redemption card, and the tangible medium. Also disclosed is a series that includes at least two toy sets.

### FIELD

The present invention relates to toy sets including a figurine and a consumable it

### BACKGROUND

A variety of children's′ games exist, but typical games do not pair the option of collecting candy with a figurine and the possibility of receiving a prize for collecting an entire series of figurines.

### SUMMARY

Disclosed is a toy set comprising: a figurine representing a miniature reproduction of an animal; a collection identifier that identifies the figurine; a redemption card configured for the collection identifier to be affixed thereto; a tangible medium having instructions provided thereon, wherein the instructions specify a manner in which the redemption card is to be submitted to redeem a prize; and a carrying case comprising a first portion and a second portion structured and arranged for connection to the first portion to define a storage compartment structured and arranged to contain the figurine, the collection identifier, the redemption card, and the tangible medium.

Also disclosed is a series comprising at least two toy sets.

These and other aspects of the present invention will be more apparent from the following figures and description.

### BRIEF DESCRIPTION OF THE DRAWINGS

FIG. 1 is an isometric view of a toy set in accordance with an example of the present invention.

FIG. 2 is an isometric view of a carrying case in accordance with an example of the present invention.

FIG. 3 is an isometric view of the carrying case of FIG. 2 showing the carrying case in the open position.

FIG. 4 is an isometric view of the carrying case of FIG. 2 showing the carrying case in the open position and including a shelf

FIG. 5 is a top view of the carrying case of FIG. 2.

FIG. 6 is a partially schematic cross-sectional view of the first portion and second portions of the carrying ease of FIG. 5 taken through line A-A.

FIG. 7 is a schematic of a redemption card.

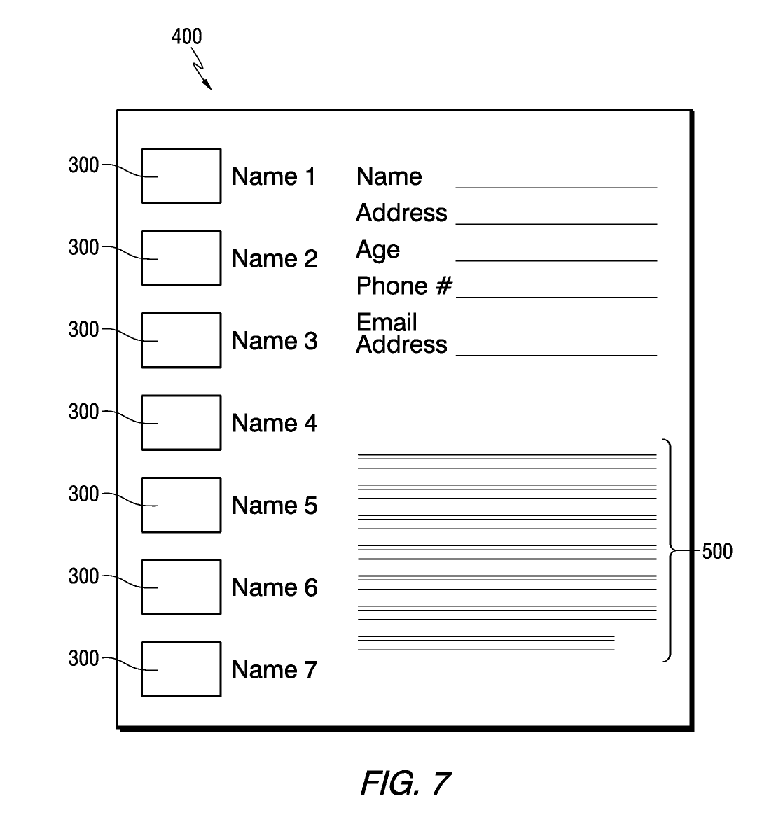

### DETAILED DESCRIPTION

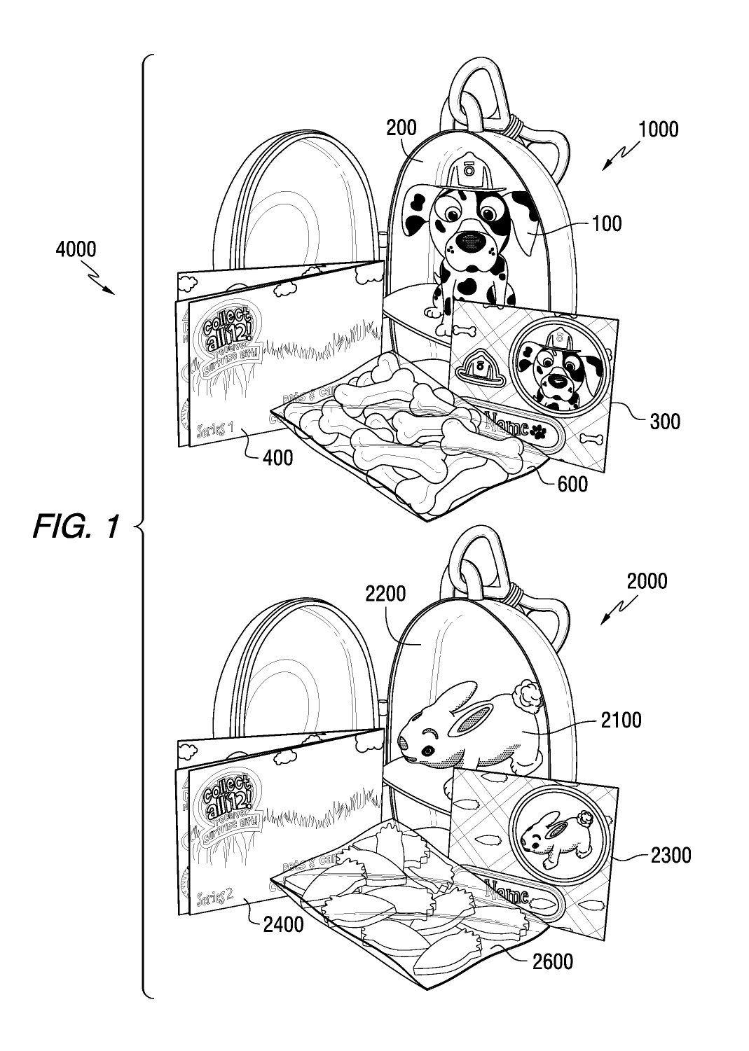

As shown in FIG. I, disclosed herein is a toy set 1000 comprising: a figurine 100 representing a miniature reproduction of an animal; a collection identifier 300 that identifies the figurine 100; a redemption card 400 configured for the collection identifier 300 to be affixed thereto; a tangible medium having instructions 500 provided thereon, wherein the instructions 500 specify a manner in which the redemption card 400 is to be submitted to redeem a prize; and a carrying case 200 comprising a first portion 210 and a second portion 220 structured and arranged for connection to the first portion 210 to define a storage compartment 290 structured and arranged to contain the figurine 100, the collection identifier 300 the redemption card 400, and the tangible medium. FIG. I illustrates a second toy set 2000 which may comprise: a figurine 2100 representing a miniature reproduction of an animal; a collection identifier 2300 that identifies the figurine 2100; a redemption card 2400 configured for the collection identifier 2300 to be affixed thereto; a tangible medium having instructions (not shown) provided thereon, wherein the instructions specify a manner in which the redemption card 2400 is to be submitted to redeem a prize; and a carrying case 2200. Similar element numbers are used to describe the same features found in toy sets 1000 and 2000, and the toy set 2000 may be of the same or similar construction as toy set 1000 described herein. As illustrated in FIG. 1, two or more toy sets 1000, 2000 may be part of a series 4000.

As shown in FIG. 1, according to the invention, the toy set 1000 comprises at least one figurine 100. As used herein, the term “figurine” includes both representations having no movable parts and those having movable parts. In examples, the figurine 100 may be molded with a base to support the figurine 100. According to the invention, the figurine 100 may represent a miniaturized reproduction of any object, article, item or the like. In the examples shown in FIG. 1, the figurine is illustrated as a miniature reproduction of an animal or a fictional character. In examples, the animal may be a mammal, an avian, an amphibian, a turtle, a tortoise, a fish, or combinations thereof. The mammal may be, for example, a primate, a canine, a feline, an equine, a bovine, a rabbit, or combinations thereof The figurine 100 may be made from a variety of materials in a variety of shapes and sizes. In an example, the figurine 100 may be produced by a die mold. In examples, the figurine 100 may be made of any suitable materials such as plastic, natural or synthetic composites, injectable molding material, textiles, and the like. For example, the figurine 100 may be made from acrylonitrile butadiene styrene. Alternately, any moldable plastic can be used for the figurine 100 or it can be made of a textile and optionally may be stuffed with a soft material.

In addition to the figurine 100, the toy set 1000 optionally may comprise at least one accessory piece accessory piece (not shown) that complements the figurine 100. For example, the accessory pieces may include, but are not limited to, clothing configured to fit the figurine, miniaturized furniture, miniaturized tableware, and the like. The accessory pieces may be made from a variety of materials in a variety of shapes and sizes. In an example, the accessory pieces may be produced by a die mold. The accessory pieces also may be made of any suitable material or combination of materials, such as injectable molding material or a textile.

According to the present invention, and as illustrated in Ha 1, the toy set 1000 also may comprise a collection identifier 300 that identifies the figurine 100. The collection identifier 300 may be imprinted or otherwise provided on any tangible medium and may comprise information relating to the figurine 100, such as at least one alphanumeric character, an image, a color, or combinations thereof. In examples where there is more than figurine 100 in the toy set 1000 or in a series 4000 of which the toy set 1000 is a part, each figurine 100 may have a unique collection identifier 300. In examples, the collection identifier 300 may identify the figurine 100 as belonging to a particular series 2000 (described below). In examples, the tangible medium may comprise an adhesive-backed substrate such as a sticker. In examples, the collection identifier 300 is configured for being affixed to any surface, including but not limited to the redemption card 400 (described below), according to the instructions 500 included with the toy set 1000 (described below).

According to the present invention, and as illustrated in FIG. 1, the toy set 1000 also may comprise a redemption card 400 configured to receive the collection identifier 300. The redemption card 400 may include a list of a plurality of figurines, such as a list of figurines included in the toy set 1000 or in a series 4000 of which the toy set 1000 is a part, a name for each figurine, and a line, space, or the like for adhering the collection identifier 300. Where the toy set 1000 is part of a series 4000, the redemption card 400 may be configured to receive each collection identifier 300 in the series 4000, such as a line for adhering or affixing each such collection identifier 300. Optionally, the redemption card 400 may list the names of each figurine 100 that is part of a series 4000, and may have a space for adhering the collection identifier 300 that corresponds to each such name so that in use, the redemption card 400 may be filled in as the end-consumer purchases toy sets 1000 that comprise the series 4000. The redemption card 400 also may include a section in which the user may populate personal information and the like, such as name, address, telephone number, email address, age, gender, and the like.

Optionally, as illustrated in FIG.1, each toy set 1000 may be part of a series 4000 comprised of at least two toy sets 1000, wherein each toy set 1000 may comprise a unique figurine 100, and wherein all figurines in the set 1000 may be related in some way. Each toy set 1000 may be provided to an end-consumer separately or in conjunction with other toy sets that are part of the series 4000.

As mentioned above and as illustrated in FIG, 1, each toy set 1000 also may comprise a tangible medium having instructions 500 provided thereon indicating a method of using the redemption card 400. The method may be one of the methods described herein.

In one example, the objective of completing the redemption card 400 may be to receive a prize upon collection of a figurine 100 comprising a toy set 1000. To this end, in one example in accordance with the present invention, each time a consumer purchases or otherwise completes a toy set 1000, the consumer may be eligible to receive a prize upon completion and submission of the redemption card 400. In such example, the instructions 500 may instruct the consumer to fill out the redemption card 400 by providing the consumer's personal information and to adhere the collection identifier 300 for the figurine 100 to the redemption card 400 in the place allocated for such collection identifier 300, such as next to said figurine's 100 name or likeness. The instructions 500 then may instruct to the consumer to submit the completed redemption card 400, such as by email or mail or the like, to redeem the redemption card 400 in exchange for a prize.

In another example, as described above and as shown in FIG. 1, the toy set 1000 may be part of a series 4000 comprised of at least unique two toy sets 1000 and the objective of completing the redemption card 400 may be to receive a prize upon collection of all of the figurines 100 in a series 4000. To this end, in an example in accordance with the present invention, the consumer may be eligible to receive a prize upon collection of all of the figurines 100 comprising the series 4000 and completion and submission of the redemption card 400. In such example, the instructions 500 may instruct the consumer to fill out the redemption card 400 by providing the consumer's personal information and to adhere the collection identifier 300 for each figurine 100 collected in the series 4000 to the redemption card 400 in the place allocated for such collection identifier 300, such as next to said figurine's 100 name or likeness. In such example, the consumer may submit a single redemption card 400 that includes the collection identifier 300 that corresponds to each figurine 100 in the series 4000, or the consumer may submit a plurality of redemption cards 400 at one time, wherein each redemption card 400 corresponds to one figurine 100 that is part of the series. The instructions then may instruct to the consumer to submit the completed redemption card 400, such as by email or mail or the like, to redeem the redemption card 400 in exchange for a prize.

In examples according to the present invention, the prize may be an additional figurine, and in some instances may be a unique figurine that is not sold as part of any toy set and that can only be acquired by redemption of completed redemption cards. In another example according to the present invention, the prize may be a consumable item such as the one described below.

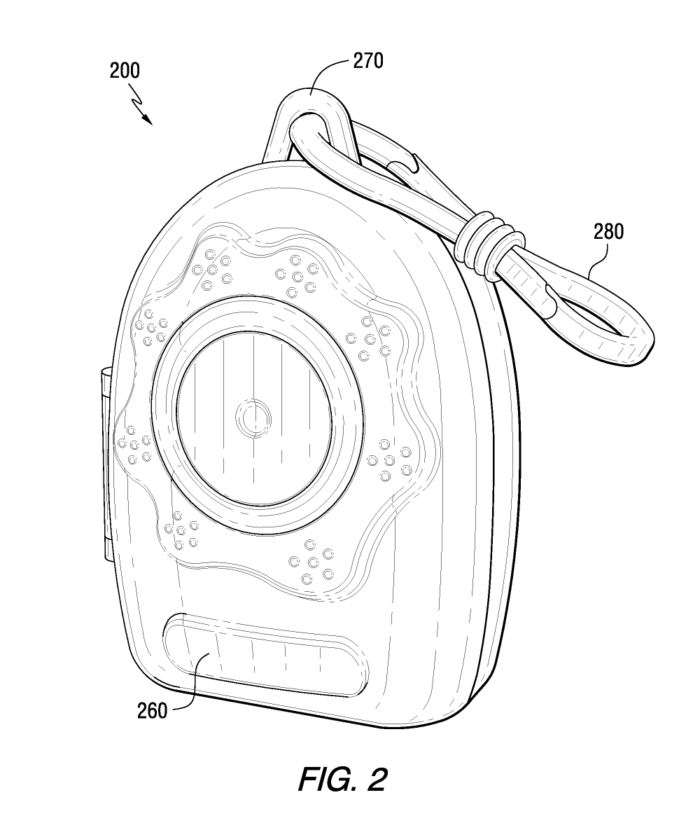

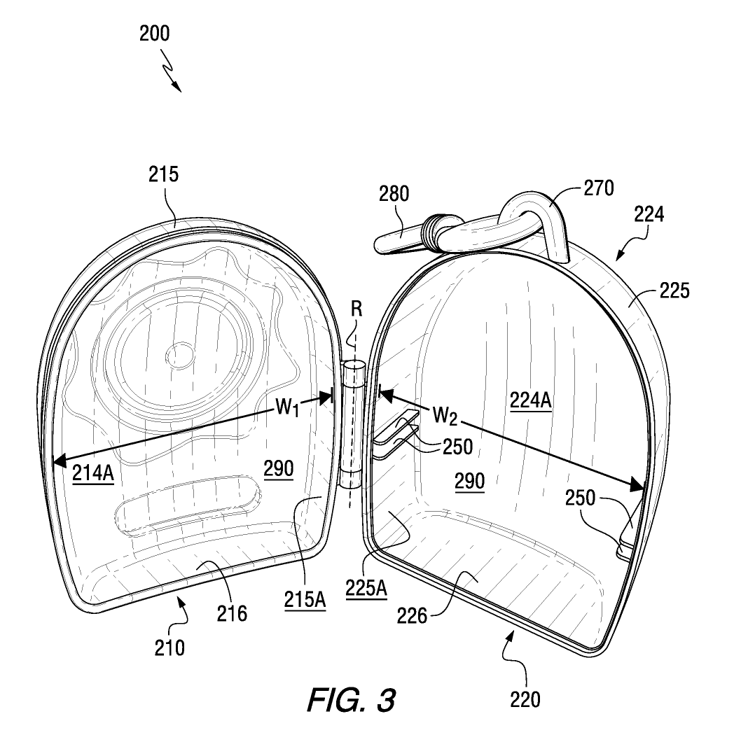

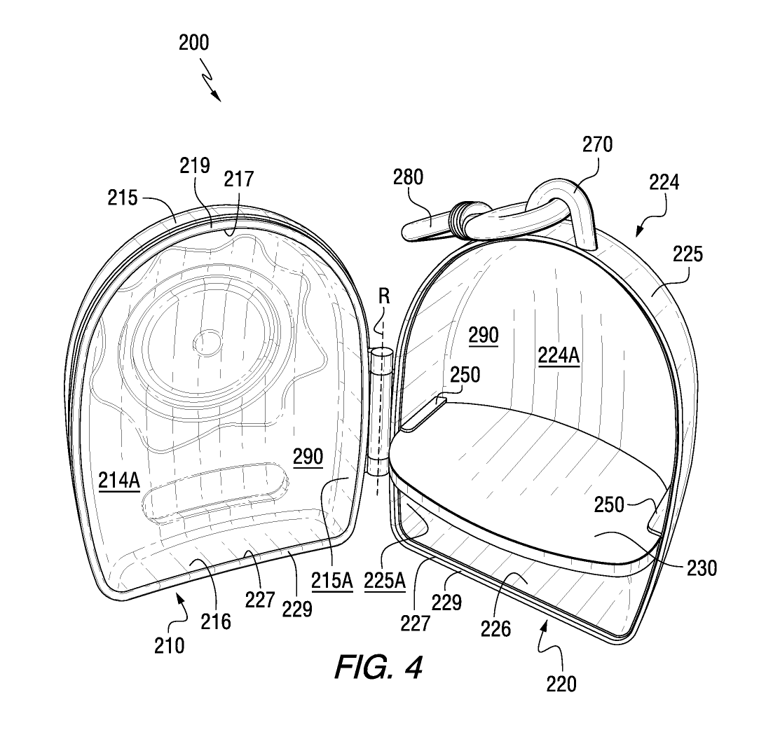

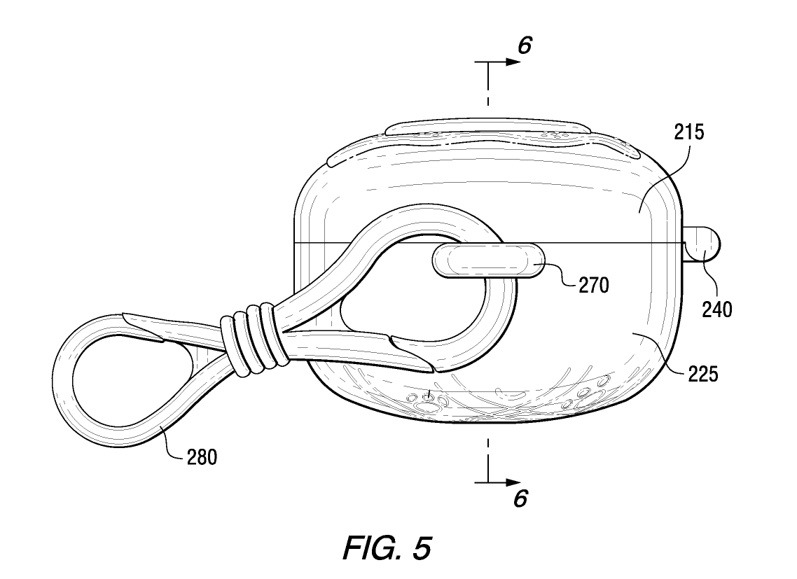

According to the invention, as shown in FIGS. 2-6, the toy set 1000 also comprises a carrying case 200. As shown in FIGS. 3 and 4, the carrying case 200 may comprise a first portion 210 and a second portion 220. Each portion, 210, 220, may comprise a major face 214, 224 and at least one perimeter wall, 215, 225 extending therefrom which define a storage compartment 290 structured and arranged to contain the figurine 100. The first portion, 210 may have a height H1 and a depth D1 and the second portion, 220 may have a height H2 and a depth D2. The storage compartment 290 may have a height H1 or H2, and a depth of no greater than D1+D2. In an example, each major face, 214, 224 and at least one perimeter wall, 215, 225 may be constructed of a single piece of molded material. Each major face 214, 224 and perimeter wall, 215, 225 has an interior surface 214A, 215A, 224A, 225A and an exterior surface 214B, 215B, 224B, 225B. In certain examples, the first perimeter wall 215 may form a first perimeter edge 217 of the first portion, 210 and the second perimeter wall 225 may form a second perimeter edge 227 of the second portion 220. In an example, at least a portion 216, 226 of each perimeter wall may be substantially planar to enable the carrying case 200 to be positioned on a substantially fiat surface.

As noted above and as shown generally in the Figures, the first portion 210 may be structured and arranged for connection to the second portion 220 to define a storage compartment 290. The first portion 210 may be pivotably mounted to the second portion 220 about an axis of rotation R. The first portion 210 may be rotatable about 180 between the closed position shown in FIG. 2 and the open position shown in FIGS. 1, 3, and 4. As shown in FIGS. 3 and 4, hinge assemblies 240 may be mounted to the perimeter wall 215, 225 of first and second portion 210, 220. Although in the examples shown in the Figures, one hinge assembly 240 is shown, in other examples the hinge assembly may be eliminated from the carrying case 200 altogether, or in other examples, any other suitable number of hinges may be used, e.g., two, three, four, etc.

First and second portions 210, 220 are configured to engage in interlocking relationship with each other when the first portion 220 is in the closed position shown in FIG. 2. The interlocking relationship may be formed using any suitable fit, for example, a friction fit, an interference fit, or the like.

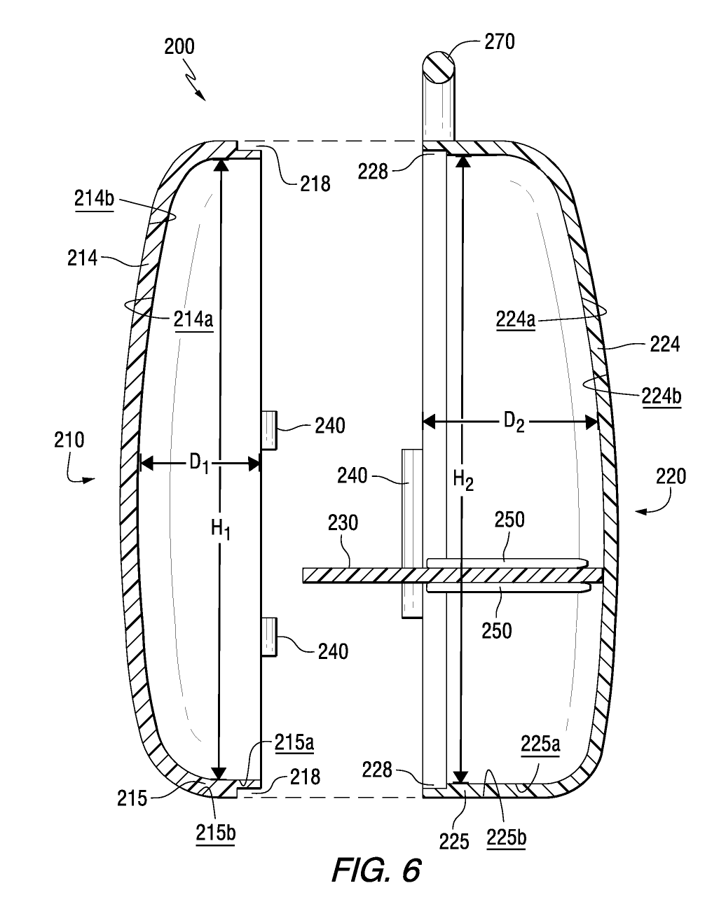

As shown in FIG. 6, the first portion 210 may have an area of reduced thickness 218 along the perimeter edge 217 that is substantially flush with the interior surface 215A of the first perimeter wall 215. The area of reduced thickness 218 may terminate in a shoulder 219 spaced a distance inwardly from the first perimeter edge 217. The area of reduced thickness 218 of the first portion 210 may be configured to telescope into the second portion 220,

As shown in FIG. 6, the second portion 220 may have an area of reduced thickness 228 along the perimeter edge 227 that is substantially flush with the exterior surface 225B of the second perimeter wall 225. The area of reduced thickness 228 may terminate in a shoulder 229 spaced a distance inwardly from the second perimeter edge 227. When the area of reduced thickness 218 of the first portion 210 is telescoped into the second portion 220, the perimeter edge 217 of the first portion 210 engages the shoulder 229 of the second portion 220 to stop the telescoping and cause an interlocking relationship between the areas of reduced thickness 218, 228. Although FIG. 6 shows the area of reduced thickness 218 of the first portion 210 telescoping into the second portion 220, in other examples, the shoulder 229 of the second portion 220 may telescope into the first portion, 210.

Optionally, the interlocking relationship also may be a snap fit. For example, a lip (not shown) may be positioned in the area of reduced thickness 218, 228 of one portion 210, 220 and a recess (not shown) may be positioned in the area of reduced thickness 228, 218 of the other portion 220, 210 such that the recess receives the lip when the area of reduced thickness 228, 218 of one portion 220, 210 is telescoped into the other portion 210, 220 to provide a removable connection between first and second portions 210, 220.

As shown in FIG. 4, the carrying case also may comprise at least one shelf 230 structured and arranged for positioning in the storage compartment 290 to support the figurine 100 thereon. The shelf 230 may be integral with the interior surface 215A of the perimeter wall 215 of one of the first or second portions 210, 220, or it may be removable. According to the present invention, the shelf 230 may have a width W3 that is substantially equal to or less than widths W1, W2 of first and second portions 210, 220, and a depth D3 that is no greater than the sum of depths D1 and D2 of first and second portions 210, 220, such as substantially equal to or less than depth D1 or D2.

As shown in FIG. 3, according to the present invention, at least one pair of opposing shelf-retaining ribs 250 may be positioned on an interior surface 225A of the second portion 220. The ribs 250 may be structured and arranged to receive the at least one shelf 230. In examples, the ribs 250 may be integral with the interior surface 225A of the perimeter wall 215, 225 of the second portion 220. Although in the examples shown in the Figures, the ribs 250 are shown in the second portion 220, in other examples, rib 250s may be positioned in the first portion 210. Additionally, although the examples shown in the Figures show only one set of ribs 250 and one shelf 230, in other examples, any suitable number of ribs 250 and shelves 290 may be used, e.g., two, three, four, etc,

As shown in FIGS. 3 and 6, the first portion 210 has a height H1, a width W1, and a depth D1, and as shown in FIGS. 3 and 6, the second portion 220 has a height H2, a width W2, and a depth D2. The dimensions of the first and second portions 210, 220 may be varied to assure that the figurine 100 may be contained therein. For example, height H1 and width W1 of the first portion 210 may be substantially equal to the height H2 and width W2, respectively, of the second portion 220 such that the interlocking relationship between the first and second portions 210, 220 may be formed.

As shown in FIGS. 3 and 6, first portion 210 has a height H1, a width W1, and a depth D1 and as shown in FIGS. 3 and 6, second portion 220 has a height 112, a width W2, and a depth D2, each selected to contain the figurine 100 and any accessory items. For example, the height H1, H2 of each portion 210, 220 may range from 0.5 to 6 inches, or from 1 to 5 inches, or from 2 to 4 inches. For example, the width W1, W2 of each portion may range from 0.5 to 6 inches, or from 1 to 5 inches, or from 1.5 to 4 inches For example, the depth D1, D2 of each portion may range from 0.1 to 4 inches, or from 0.25 to 3 inches, or from 0.5 to 2.5 inches.

In examples, height H1 of the first portion 210 may be greater than width W1 of the first portion 210, and likewise height H2 of the second portion 220 may be greater than width W2 of the second portion 220. For example, height H1 of the first portion, 210 may be from 5 to 200 percent greater, for example, 10 to 150 percent greater, or 20 to 100 percent greater than the width W1 of the first portion 210, and height H2 of the second portion 220 may be from 5 to 200 percent greater, for example, 10 to 150 percent greater, or 20 to 100 percent greater than the width W2 of the second portion 220. For example, the ratio of H1:W1 and H2:W2 may be from 0.5:1 to 4:1, for example, from 1:1 to 2:1. In examples, the depth D2 of the second portion 220 may be greater than the depth D1 of the first portion 210. For example, the depth D2 of the second portion 220 may be from 5 to 200 percent greater, for example, 50 to 180 percent greater, or 75 to 125 percent greater than the depth D1 of the first portion 210.

In examples, the first and second portions 210, 220 may be secured in the closed position by a latch, lock and the like.

According to the invention and as shown in the figures, the exterior surface 214A, 224A of each major face 214, 224 may be configured for application of a name plate 260, image or the like. In examples, the name plate 260, image and the like may be imprinted on a tangible medium such as an adhesive-backed substrate such as a sticker, as illustrated in FIG. 1. In other examples, the name plate 260, image and the like may be formed in or on the exterior surface 214A (not shown). Although the figures shows the name plate 260 positioned on the exterior surface 214A of the major face 214 of the first portion 210, in other examples, the name plate 260 may be positioned on other parts of the carrying ease 200, including but not limited to, the exterior surface 224B of the major face of the second portion 220.

As illustrated in FIGS. 2-5, a hook receiving loop 270 optionally may be integral with or positioned on the exterior surface of the second portion 220. Optionally, the carrying case 200 may comprise a detachable hook 280 structured and arranged for receipt by the hook receiving loop 270. The detachable hook 280 may be configured to attach at a first end to the hook receiving loop 270 and at a second end to a belt, belt loop, strap, or the like. Although the figures show the hook receiving loop 270 positioned on the exterior surface 225B of the perimeter wall of the second portion 225, the hook receiving loop 270 may be positioned on other parts of the carrying case 200.

The carrying case 200 and shelf 230, may be made of any suitable materials such as plastic, metal, natural or synthetic composites, injectable molding material, textiles, and the like. For example, the carrying case may be made from ABS plastic. Alternately, any moldable plastic can be used for the carrying case.

As shown in FIG. 1, the toy set 1000 also may comprise a consumable food item 600 such as candy, chewing gum, bubble gum, and the like.

Optionally, a wrapper may enclose the carrying case 200. The wrapper may be made of any of a variety of materials and may be made to conform to the contours of the carrying case 200. The wrapper may be clear or may have imprinted thereon or affixed thereto information about the toy set 1000, including contents of the toy set, nutritional information related to the consumable food item 600, and the like.

Whereas particular embodiments of this invention have been described above for purposes of illustration, it will be evident to those skilled in the art that numerous variations of the details of the present invention may be made without departing from the invention as defined in the appended claims.

1. A toy set comprising:
a figurine representing a miniature reproduction of an object;
a collection identifier that identifies the figurine;
a redemption card configured for the collection identifier to be affixed thereto;
a consumable item;
a tangible medium having instructions provided thereon, wherein the instructions specify a manner in which the redemption card is to be submitted to redeem a prize; and
a carrying case, comprising;
a first portion; and
a second portion structured and arranged for connection to the first portion to define a storage compartment structured and arranged to contain the figurine, the collection identifier, the redemption card, and the tangible medium.

2. The toy set according to claim 1, wherein the figurine comprises a mammal, an avian, an amphibian, a turtle, a tortoise, a fish, or combinations thereof.

3. The toy set according to claim 2, wherein the mammal comprises a primate, a canine, a feline, an equine, a bovine, a rabbit, or combinations thereof.

4. The toy set according to claim 1, wherein the collection identifier is provided on a second tangible medium and comprises at least one alphanumeric character, an image, a color, or combinations thereof.

5. The toy set according to claim 4, wherein the second tangible medium comprises an adhesive-backed substrate,

6. The toy set according to claim 1, wherein the redemption card is configured for at least a second collection identifier to be affixed thereto, the second collection identifier identifying a second figurine representing a miniature reproduction of a second object.

7. The toy set according to claim 1, wherein the first portion of the carrying case has a first depth, a first height, and a first width, and the second portion of the container has a second depth, a second height, and a second width.

8. The toy set according to claim 1, wherein the first portion is pivotably attached to the second portion about an axis of rotation.

9. The toy set according to claim 1, further comprising a shelf structured and arranged for positioning in the storage compartment to support the figurine thereon, wherein the shelf has a third depth and a third width.

10. The toy set according to claim 9, further comprising a pair of opposing shelf-retaining ribs positioned on an interior surface of the second portion structured and arranged to receive the shelf.

11. The toy set according to claim 1, further comprising a hook receiving loop.

12. The toy set according to claim 11, further comprising a hook structured and arranged for receipt by the hook receiving loop.

13. (canceled)

14. (canceled)

15. The toy set according to claim 1, further comprising a name plate configured for placement on a surface of the container.

16. The toy set according to claim 15, wherein the name plate is imprinted on an adhesive-backed substrate.

17. The toy set according to claim 1, further comprising an image of the figurine configured for placement on a surface of the container.

18. The toy set according to claim 17, wherein the image is imprinted on an adhesive-backed substrate.

19. A series comprising at least two of the toy sets according to claim 1.

20. The toy set according to claim 1, wherein the redemption card comprises a section in which a user may populate personal information.
